(19) United States
(12) Patent Application Publication
(10) Pub. No.: US 2013/0202334 A1
(43) Pub. Date: Aug. 8, 2013

(54) IMAGE HEATING APPARATUS

(71) Applicant: CANON KABUSHIKI KAISHA, Tokyo (JP)

(72) Inventor: Masahiro Takahashi, Kashiwa-shi (JP)

(73) Assignee: CANON KABUSHIKI KAISHA, Tokyo (JP)

(21) Appl. No.: 13/752,836

(22) Filed: Jan. 29, 2013

(30) Foreign Application Priority Data
Feb. 3, 2012 (JP) 2012-022281

(51) Int. Cl. G03G 15/20

(52) U.S. Cl. CPC G03G 15/2064
USPC 399/329

(57) ABSTRACT

An image heating apparatus comprising: a rotatable heating member for heating a toner image on a sheet at a nip; an endless belt for forming the nip between itself and the rotatable heating member; and a pressing pad for pressing the endless belt toward the rotatable heating member, wherein the pressing pad includes: a base portion provided extended at least from an entrance portion of the nip to an exit portion of the nip; and an elastic layer provided on the base portion, wherein the elastic layer has a thickness which is thinner in a first region adjacent the entrance portion of the nip than in a second region adjacent the exit portion of the nip.

### FIELD OF THE INVENTION AND RELATED ART

The present invention relates to an image heating apparatus for heating a toner image on a sheet. The image heating apparatus is used in, e.g., an image forming apparatus such as a copying machine, a printer, a facsimile machine or a multi-function machine having a plurality of functions of these machines.

In an electrophotographic image forming apparatus, a fixing apparatus (image heating apparatus) for fixing a toner image formed on a recording material (sheet) has been conventionally mounted.

Further, in Japanese Laid-Open Patent Application (JP-A) 2006-146156, with speed-up of image formation in mind, a fixing apparatus using a belt has been proposed in order to extend a width of a nip with respect to a recording material conveyance direction.

Incidentally, in such a fixing apparatus using the belt, a constitution in which the nip is formed by using a stretching roller and a pressing pad is employed and therefore there is a possibility of a lowering in pressure at a boundary portion between the stretching roller and the pressing pad. When the pressure is largely lowered, resulting from generation of water vapor and inclusion of air, there is a possibility that uneven glossiness is generated in a fixed image.

For that reason, in the fixing apparatus described in JP-A 2006-146156, into a wedge-like space formed at the boundary portion between the stretching roller and the pressing pad, a low-friction sheet material folded into two is inserted, thus meeting this possibility.

In recent years, a user is desired to use various recording materials including a recording material having high surface hermeticity, or the like, such as resin-coated paper, a resin sheet or the like, but in the case of such a recording material, there is a possibility that the above problem is more noticeable.

Therefore, a meeting property to such various recording materials is enhanced and thus in order to meet a user's demand, the fixing apparatus is required to more decrease a degree of the lowering in pressure at the nip.

### SUMMARY OF THE INVENTION

A principal object of the present invention is to provide an image heating apparatus capable of suppressing a lowering in pressure at a nip.

According to an aspect of the present invention, there is provided an image heating apparatus comprising: a rotatable heating member for heating a toner image on a sheet at a nip; an endless belt for forming the nip between itself and the rotatable heating member; and a pressing pad for pressing the endless belt toward the rotatable heating member, wherein the pressing pad includes: a base portion provided extended at least from an entrance portion of the nip to an exit extended of the nip; and an elastic layer provided on the base portion, wherein the elastic layer has a thickness which is thinner in a first region adjacent the entrance extended of the nip than in a second region adjacent the exit extended of the nip.

According to another aspect of the present invention, there is provided an image heating apparatus comprising: a rotatable heating member for heating a toner image on a sheet at a nip; an endless belt for forming the nip between itself and the rotatable heating member; a pressing pad for pressing the endless belt toward the rotatable heating member, wherein the pressing pad includes: a base portion provided extended at least from an entrance portion of the nip to an exit portion of the nip; and an elastic layer provided on the base portion; and a pressing mechanism for pressing the pressing pad toward the rotatable heating member so that pressure in a first region adjacent the entrance portion of the nip is larger than that in a second region adjacent the exit portion of the nip.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a fixing apparatus in Comparison Example.

FIG. 3 is an enlarged view of a nip in the neighborhood of a pressing pad.

FIG. 4 is an illustration of a pressure distribution at the nip with respect to a recording material conveyance direction.

FIG. 5 is an illustration of uneven glossiness of an output image.

FIG. 6 is an illustration of a structure of a fixing apparatus in Embodiment 1.

FIG. 7 is an enlarged view of a nip in the neighborhood of a pressing pad.

FIG. 8 is an illustration of a pressure distribution at a nip with respect to a recording material conveyance direction.

FIG. 9 is an illustration of a structure of a fixing apparatus in Embodiment 2.

FIG. 10 is an illustration of a structure of a fixing apparatus in Embodiment 3.

FIG. 11 is an enlarged view of a nip in the neighborhood of a pressing pad.

### DESCRIPTION OF THE PREFERRED EMBODIMENTS

Embodiments of the present invention will be described specifically with reference to the drawings.

An image heating apparatus includes, other than a fixing apparatus (fixing device), a surface heating apparatus for adjusting glossiness or surface property of an image. The image heating apparatus can be carried out in the form of, other than a mounted from in an image forming apparatus, a single apparatus which is mounted and operated alone or as a component unit.

An image forming apparatus can be carried out invention irrespective of types of monochromatic/full-color, sheet-feeding/recording material conveyance/intermediary transfer, a toner image forming method, and a transfer method. In the following embodiments, only a principal portion of the image forming apparatus concerning formation/transfer of the toner image will be described but the present invention can be carried out in image forming apparatuses with various uses including printers, various printing machines, copying machines, facsimile machines, multi-function machines, and so on by adding necessary equipment, options, or casing structures.

### <Image Forming Apparatus>

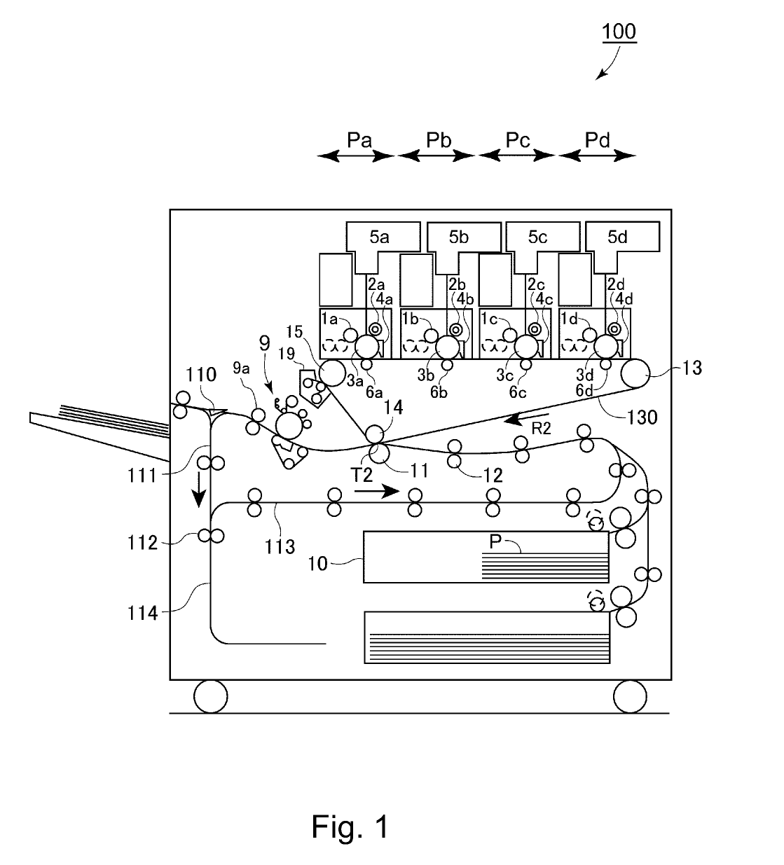

FIG. 1 is an illustration of structure of an image forming apparatus. As shown in FIG. 1, an image forming apparatus 100 in this embodiment is a tandem-type full-color printer of an intermediary transfer type in which image forming portions Pa, Pb, Pc and Pd for yellow, magenta, cyan and black, respectively, are arranged along an intermediary transfer belt 130.

In the image forming portion Pa, a yellow toner image is formed on a photosensitive drum 3a and then is primary-transferred onto the intermediary transfer belt 130. In the image forming portion Pb, a magenta toner image is formed on a photosensitive drum 3b and is primary-transferred onto the intermediary transfer belt 130. In the image forming portions Pc and Pd, a cyan toner image and a black toner image are formed on photosensitive drums 3c and 3d, respectively, and are primary-transferred successively onto the intermediary transfer belt 130.

A recording material P is taken out from a recording material cassette 10 one by one by and is in stand-by between registration rollers 12. The recording material P is sent by the registration rollers 12 to a secondary transfer portion T2 while being timed to the toner images on the intermediary transfer belt 130, so that the toner images are secondary-transferred from the intermediary transfer belt 130 onto the recording material P. The recording material P on which the four color toner images are secondary-transferred is conveyed into a fixing apparatus 9 is, after being heated and pressed by the fixing apparatus 9 to fix the toner images thereon, discharged onto a tray outside the image forming apparatus.

In the case of double-side printing, the recording material P on which first surface the toner images are transferred and fixed by the fixing apparatus 9 is guided into a reversing path 114 by a flapper 110. The recording material P in the reversing path 114 is reversed by a reversing roller 112 to be guided to a path 113 for double-side printing. Then, the recording material P is again in stand-by between the registration rollers 12 and is sent to the secondary transfer portion T2, where the toner images are transferred onto a second surface of the recording material P and then the toner images are fixed on the second surface of the recording material P. Thereafter, the recording material P on which the images are fixed on its first and second surfaces is discharged to the outside of the image forming apparatus.

The image forming portions Pa, Pb, Pc and Pd have the substantially same constitution except that the colors of toners of yellow, magenta, cyan and black used in developing devices 1a, 1b, 1c and 1d are different from each other. In the following description, the image forming portion Pa for yellow will be described and other image forming portions Pb, Pc and Pd will be omitted from redundant description.

The image forming portion Pa includes the photosensitive drum 3a around which a charging roller 2a, an exposure device 5a, the developing device 1a, a primary transfer roller 6a, and a drum cleaning device 4a are provided. The photosensitive drum 3a is prepared by forming a photosensitive layer on the surface of an aluminum cylinder. The charging roller 2a electrically charges the surface of the photosensitive drum 3a to a uniform potential. The exposure device 5a writes (forms) an electrostatic image for an image on the photosensitive drum 3a by scanning with a laser beam. The developing device 1a develops the electrostatic image to form the toner image on the photosensitive drum 3a. The primary transfer roller 6a is supplied with a voltage, so that the toner image on the photosensitive drum 3a is primary-transferred onto the intermediary transfer belt 130.

The drum cleaning device 4a rubs the photosensitive drum 3a with a cleaning blade to collect a transfer residual toner deposited on the photosensitive drum 3a without being transferred onto the intermediary transfer belt 130. A web cleaning 15 rubs the intermediary transfer belt 130 with a cleaning web to collect a transfer residual toner deposited on the intermediary transfer belt 130 without being transferred onto the recording material P.

### COMPARISON EXAMPLE

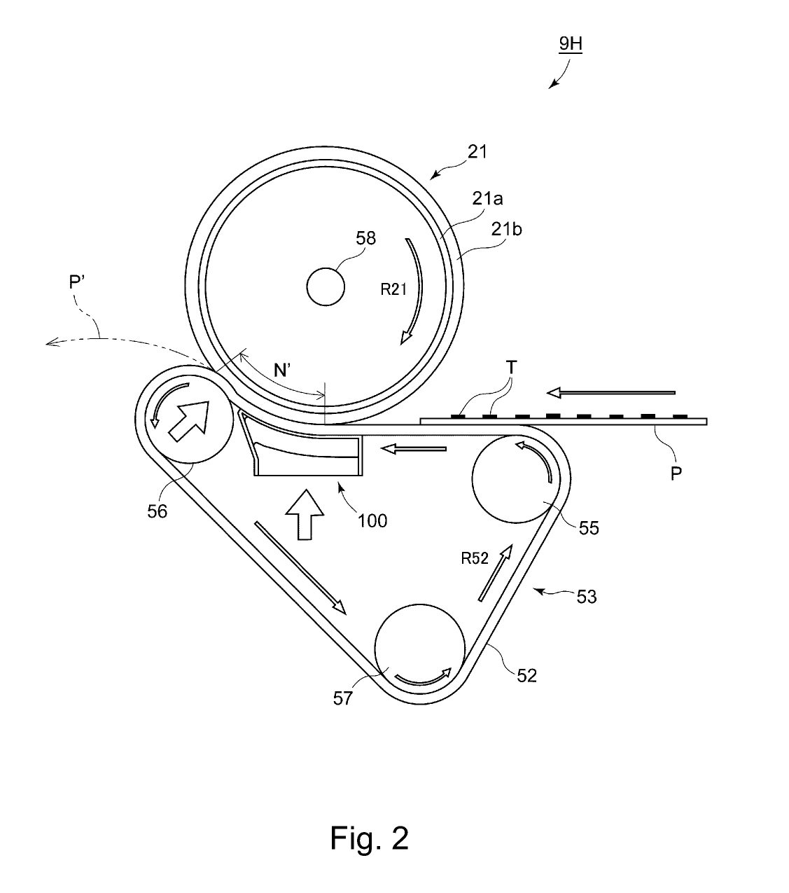

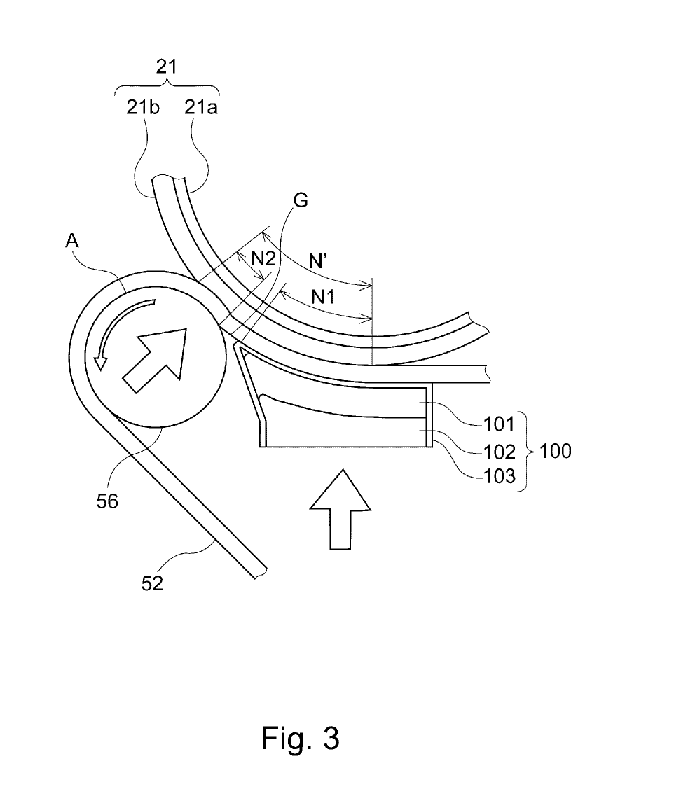

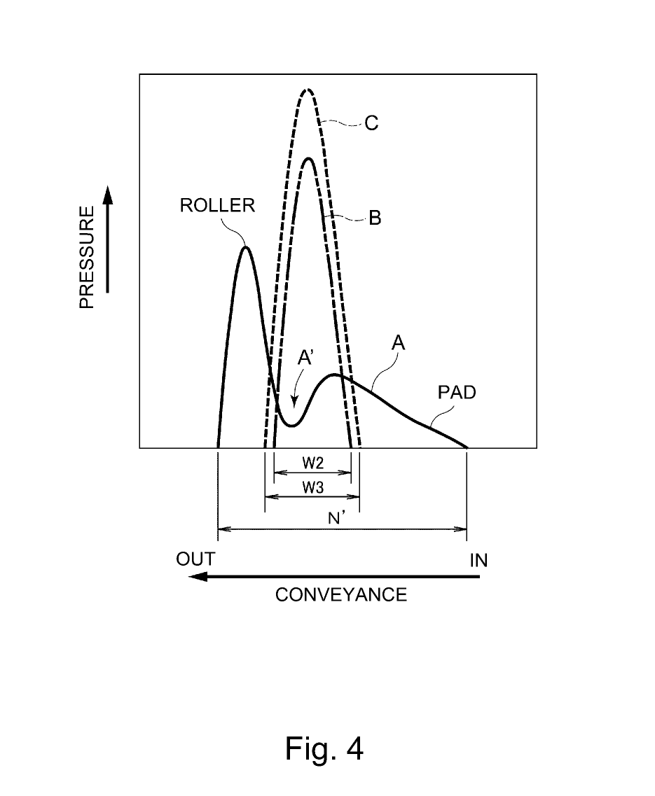

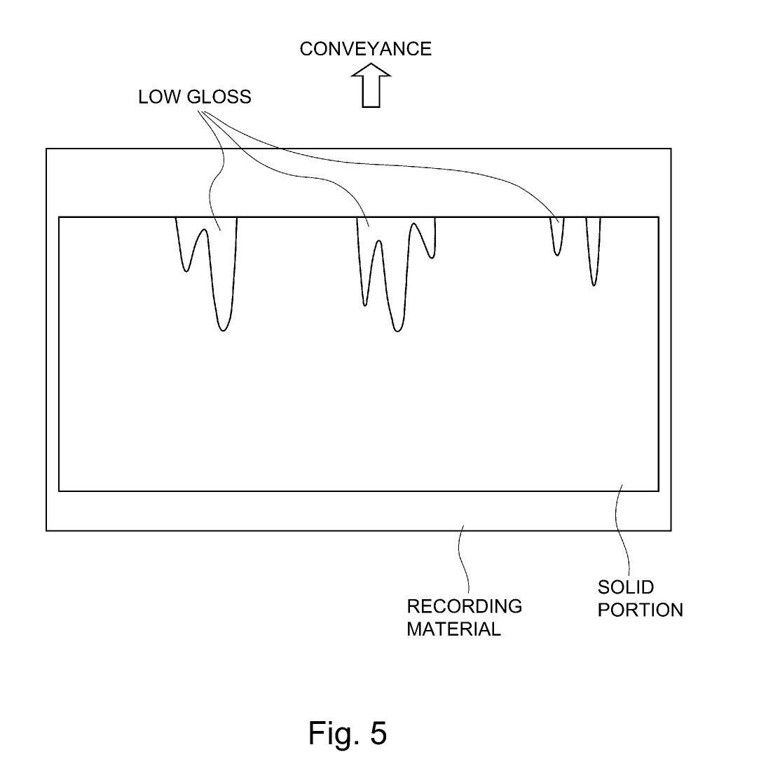

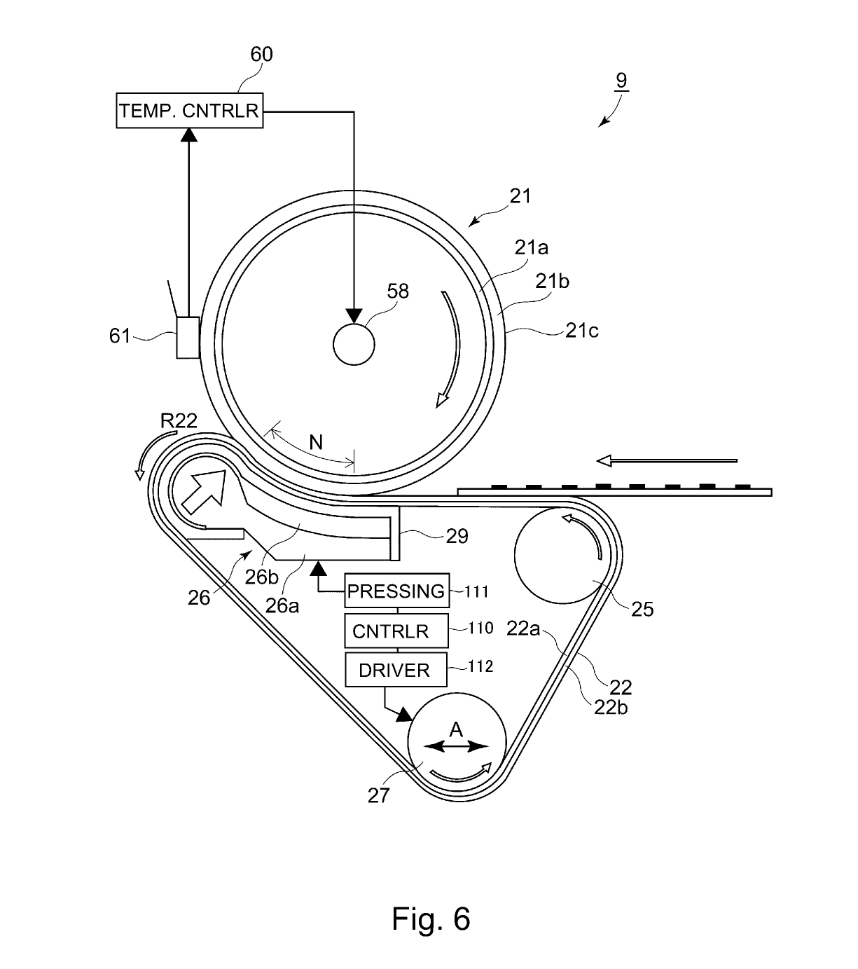

FIG. 2 is an illustration of a structure of a fixing apparatus in Comparison Example. FIG. 3 is an enlarged view of a nip in the neighborhood of a pressing pad. FIG. 4 is an illustration of a pressure distribution at the nip with respect to a recording material conveyance direction. FIG. 5 is an illustration of uneven glossiness of an output image. FIG. 6 is an illustration of a state of the nip observed by opening the nip during fixing of toner images.

As shown in FIG. 2, in a fixing apparatus 9H in Comparison Example, under a fixing roller 21 rotatably provided, a belt unit 53 is provided. The belt unit 53 includes an entrance roller 55, a separation roller 56 and a steering roller 57 around which a pressing belt 52 is stretched in a triangular shape, and a pressing pad 100 is provided adjacent to the separation roller 56.

As shown in FIG. 3, the pressing pad 100 includes a pressing pad base 102 of stainless steel on which an elastic layer 101 of silicone rubber is fixed, and a sliding surface with respect to the pressing belt 52 is covered with a sliding sheet (slidable sheet) 103 containing a fluorine-containing resin material and having a low friction coefficient.

In the fixing apparatus 9H, the pressing belt 52 pressed by the separation roller 56 and the pressing pad 100 at its inner surface is press-contacted to the fixing roller 21 to form a nip N′, between the fixing roller 21 and the pressing belt 52, elongated in a recording material conveyance direction.

As shown in FIG. 4, the nip N′ in the fixing apparatus 9H in Comparison Example is formed in a length longer, with respect to the recording material conveyance direction, than that of a nip W2 in a conventional fixing apparatus of a roller fixing type. The fixing apparatus 9H of a belt fixing type has been advantage that the nip N′ can be made remarkably longer than that of the fixing apparatus of the roller fixing type.

Incidentally, a pressure distribution C in FIG. 4 shows the case where pressure of the pressing roller is increased by thickening the elastic layer of the fixing roller. In the case where the pressure of the pressing roller is increased by thickening the elastic layer of the fixing roller, a nip W3 is somewhat longer than the original nip W2 but is far inferior to the nip N′ of the fixing apparatus 9H in Comparison Example. Further, a thick elastic layer has a large thermal capacity and heat responsiveness is impaired, so that the case where the pressing roller pressure is increased is disadvantageous in terms of electric power consumption and temperature contact.

However, a pressure distribution B of the conventional fixing apparatus of the roller fixing type at the nip W2 with respect to the recording material conveyance direction has a single peak. On the other hand, a pressure distribution A of the fixing apparatus 9H in Comparison Example at the nip N′ with respect to the recording material conveyance direction has two peaks.

As shown in FIG. 2, at the nip N′ of the fixing apparatus 9H in Comparison Example, there is a region G, where there is no member for urging the pressing belt inner surface toward the fixing roller, between a portion N1 formed by the pressing pad 100 and a portion N2 formed by the separation roller. In the region G, a pressure-lowered portion A′ in the pressure distribution A is formed. Even at the pressure-lowered portion A′, the pressure is not zero but is substantially continued by tension or the like of the pressing belt 52.

As shown in FIG. 5, in the fixing apparatus 9H in Comparison Example, in the case where high-speed fixing is executed in a high-humidity environment by using a recording material, having low air permeability such as coated paper, an icicle-like low-glossiness portion (hereinafter referred to as uneven glossiness) is liable to occur on the surface of a high-density output image. In the case where adverse conditions such as the low-permeability recording material, the high humidity and the high-speed fixing are multiplied, image disturbance by generation of expansion of air and water vapor at the N′ occurs in some cases.

This may be attributable to the following phenomenon. The air and water vapor present in the unfixed toner layer stagnate at the pressure-lowered portion A′ where the pressure is low at the nip N′, i.e., in the region G between the pressing pad 100 and the separation roller 56. There is a possibility that the air and water vapor partly generate a gap at a boundary between the recording material P and the fixing roller 21 and prevent heat conduction thereby to adversely affect the toner image which is not completely fixed on the recording material P.

Therefore, in the following embodiments, a pressing member for pressing (urging) the pressing belt inner surface toward the fixing roller over a whole region of the nip with respect to the recording material conveyance direction is provided to decrease a degree of the pressure lowering at the nip, so that image defect such as uneven glossiness is not readily generated.

### Embodiment 1

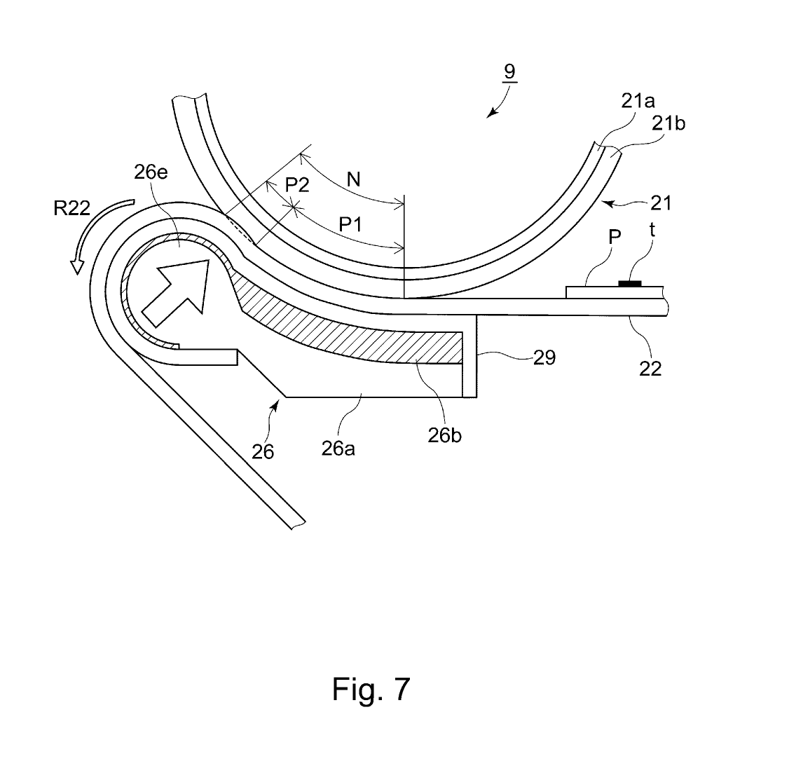

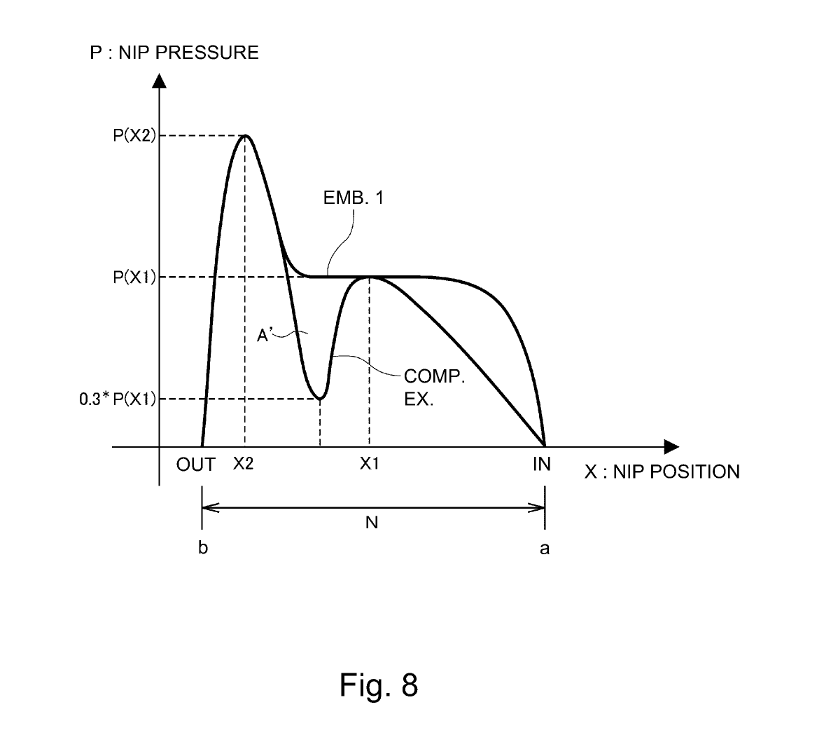

FIG. 6 is an illustration of a structure of a fixing apparatus (image heating apparatus) in Embodiment 1. FIG. 7 is an enlarged view of a nip in the neighborhood of a pressing pad. FIG. 8 is an illustration of a pressure distribution at a nip with respect to a recording material conveyance direction.

As shown in FIG. 6, the fixing roller 21 which is an example of a rotatable heating member includes an elastic layer 21b and heats an image surface of the recording material. The pressing belt 22 which is an example of a pressing belt member contacts the fixing roller 21 to form the nip N for the recording material (sheet). The recording material having passed through the nip N is separated from the fixing roller 21 at a position where the recording material is pressed by the pressing pad 26.

The pressing pad 26 includes an elastic layer 26b for elastically pressing the fixing roller 21 and a base layer (base portion) 26a for supporting the elastic layer 26b and for developing the pressing pad 26 relative to the fixing roller 21, and the elastic layer 26b is provided on the base layer 26a. The pressing pad 26 presses the fixing roller 21, which is the example of the rotatable heating member, from an inside of the pressing belt 22 which is an example of an endless belt, thus forming the nip N, where the recording material is nipped and conveyed, between the fixing roller 21 and the pressing belt 22.

The pressing pad 26 has hardness larger at a surface, where it presses the fixing roller 21 at a position where the recording material is separated, than that at a surface where it presses the fixing roller 21 in its upstream side with respect to the recording material conveyance direction. A thickness of the elastic layer in the upstream side of the nip N with respect to the recording material conveyance direction is larger than that of the elastic layer in a downstream side of the nip N with respect to the recording material conveyance direction.

The pressing pad 26 is fixed to the fixing apparatus in a non-rotatable manner. Further, the pressing pad 26 continuously presses the pressing belt 22 from the inside (of the pressing belt 22) in a range from an entrance to an exit of the nip N along a peripheral surface of the fixing roller 21 and changes a movement direction of the pressing belt 22 in an exit portion of the nip N.

Further, the pressing pad 26 compresses the elastic layer 21b of the fixing roller 21 in the exit side (at a recording material separation position) of the nip N and is configured to cause the recording material to be easily curvature-separated from the fixing roller 21. Further, an amount of the compression is decreased, without being increased, at a position from the exit portion toward the entrance portion of the nip N.

Further, the pressing pad 26 is covered with the sliding sheet 29, which is an example of a sheet member constituted by the fluorine-containing resin material, in at least a range from a curved position (a belt direction changing position) of the pressing belt 22 to the entrance of the nip N via the exit of the nip N. The pressing pad 26 includes the elastic layer 26b for continuously supporting the sliding sheet 29 over at least a range from the exit of the nip N to the entrance of the nip N. The elastic layer 26b has a thickness which is thinner in the exit portion of the nip N than that in the entrance portion of the nip N.

The fixing roller 21 is prepared by forming a 2 mm-thick elastic layer 21b of a silicone rubber material on a peripheral surface of a 2 mm-thick cylindrical core metal 21a of an aluminum alloy material and 56 mm in diameter. In order to facilitate parting of the recording material from the fixing roller 21, the peripheral surface of the elastic layer 21b is covered with a 30 μm-thick parting layer 21c of a tube of a fluorine-containing resin material (PFA). An outer diameter of the fixing roller 21 is 60 mm.

Inside the fixing roller 2, a halogen lamp heater 58 is provided. A thermistor 61 is disposed in contact or non-contact with the fixing roller 21. A temperature control circuit 60 effects, on the basis of a detection temperature of the thermistor 61, temperature control so that a surface temperature of the fixing roller 21 is kept at a predetermined target temperature by controlling voltage supply to the halogen lamp heater 58.

The pressing belt 22 is a seamless endless belt including a polyimide base layer 22a of 90 mm in diameter and 100 μm in thickness. Onto the base layer 22a, a 0.2 mm-thick elastic layer 22b of a silicone rubber material is coated.

The pressing belt 22 is stretched by the entrance roller 25, the pressing pad 26 and the steering roller 27 and is rotationally driven by a driving force inputted from an unshown driving source to the entrance roller 25, thus being rotated in an arrow R22 direction.

The entrance roller 25 also functions as a stretching roller disposed in an entrance portion where the recording material enters the fixing apparatus 9, and a position of its rotation center shaft is fixed to a frame of the fixing apparatus 9 so that a recording material conveying path is not changed.

The steering roller 27 is rotated by rotation of the pressing belt 22. The steering roller 27 controls lateral movement of the pressing belt 22, such that the pressing belt 22 moves in a rotational axis direction of the entrance roller 25, while applying predetermined tension to the pressing belt 22.

The steering roller 27 is supported at its end portion movably in an arrow A direction. When the pressing belt 22 is laterally moved in the rotational axis direction of the entrance roller 25, an amount of lateral movement (deviation) is detected by a belt edge sensor provided at a predetermined widthwise position of the pressing belt 22. A driving mechanism 112 and a control device 110 move the end portion of the steering roller 27 depending on an output of the belt edge sensor to generate a new lateral movement which cancels cut the above lateral movement, so that a widthwise position of the pressing belt 22 is kept constant.

As shown in FIG. 7, the pressing pad 26 forms a double structure such that the silicone rubber elastic layer 26b is applied onto the stainless pressing pad base 26a. The nip N is constituted by a pressing portion P1, where the pressing belt 22 is press-contacted to the fixing roller 21 with a uniform pressure distribution, and a separating portion P2 which enters the fixing roller 21 more than the pressing portion P1.

The pressing pad 26 is urged toward the fixing roller 21 via the pressing belt 22 by a pressing mechanism 111 provided in the pressing pad base 26a side. The pressing mechanism (spring) 111 is provided at each of end portions of the pressing pad 26 with respect to a longitudinal direction of the pressing pad base 26a (rotational axis direction of the fixing roller 21), so that the pressing pad 26 urged by the pressing mechanism 111 press the pressing belt 22 against the fixing roller 21. The pressing mechanism 111 applies pressure of 980N (100 kgf) in total to the pressing pad 26.

The fixing apparatus 9 can easily set a length of the nip N along the recording material conveyance direction at a large value by adjusting a length in which the pressing belt 22 is pressed against the fixing roller 21. The fixing apparatus 9 can ensure the length of the nip N along the recording material conveyance direction without relying on a diameter of the fixing roller 21, so that the fixing roller 21 can be reduced in diameter and thermal capacity and thus a rise time during switch-on can be shortened.

The fixing apparatus 9 increases the length of the nip N along the recording material conveyance direction, so that a larger amount of the toner can be melted and therefore the fixing apparatus 9 is suitable for a full-color image forming apparatus using a large amount of the toner.

As shown in FIG. 7, the pressing belt 22 enters the fixing roller 21 at an exit portion 26e of the pressing pad base 26a more than at a portion where the pressing belt 22 is uniformly urged. A cylindrical surface of the exit portion 26e locally dents the elastic layer 21b of the fixing roller 21, so that ability to curvature-separate the recording material P from the surface of the fixing roller 21 is enhanced. The exit portion 26e is set to have an outer diameter of 15 mm.

The sliding sheet 29 alleviates a sliding resistance between the pressing pad 26 and the pressing belt 22 which slide (via the sliding sheet 29) in a pressed (urged) state. The sliding sheet 29 is provided so as to cover a whole region of the elastic layer 26b to alleviate a sliding resistance between the surface of the elastic layer 26b and the inner surface of the pressing belt 22. As the sliding sheet 29, a glass cloth sheet coated with a fluorine-containing resin material (PTFE) is used. The sliding sheet 29 has a thickness of 100 μm.

The elastic layer 26b of the pressing pad 26 causes a contact surface of the sliding sheet 29 contacting the inner surface of the pressing belt 22 to follow a curve of an outer peripheral surface of the fixing roller 21. The pressing pad 26 is urged toward the fixing roller 21 under a load of a certain value or more, so that the elastic layer 26b is deformed and thus the contact surface of the sliding sheet 29 is deformed to follow the outer peripheral surface of the fixing roller 21. The pressing pad 26 urges the fixing roller 21 via the pressing belt 22, so that the pressing belt 22 is press-contacted to the fixing roller 21 with no clearance. Further, in this embodiment, a constitution in which the thickness of the elastic layer 26b at the pressing portion P1 is larger than that at the separating portion P2 is employed.

The pressing pad base 26a is a member of stainless steel, and the elastic layer 26b is silicon rubber having a rubber hardness Hs of 30 degrees. The hardness of the pressing pad base 26b is larger than that of the elastic layer 26b. At the pressing portion P1, the elastic layer 26b has curvature of 30 mm in diameter and has a shape such that it contacts a rectilinear line parallel to the pressing pad base 26a at an entrance portion of the nip. The thickness of the elastic layer 26b is 3 mm at the pressing portion P1 and 0.5 mm at the separating portion P2. The thickness of the pressing pad base 26a at the pressing portion P1 is smaller than that at the separating portion P2.

The thickness of the elastic layer and the thickness of the pressing pad base 26a are those with respect to a direction perpendicular to the surface of the recording material P to be conveyed. As described above, by adjusting the thickness of the elastic layer 26b and the thickness of the pressing pad base 26a, a hardness at the separating portion P2 measured from above the sliding sheet 29 can be made larger than that at the pressing portion P1. As a result, a separating property of the recording material P can be enhanced without providing a separating member separately from the pressing pad 26. In this embodiment, the shape of the pressing pad base 26a at the separating portion P2 is an arcuate shape.

As shown in FIG. 8, in the fixing apparatus 9 in this embodiment, a pressure distribution of the pressing pad 26 at the nip N is such that the pressure is substantially constant at the pressing portion P1 and is maximum at the separating portion P2 and that a peak pressure at the separating portion P2 is higher than that at the pressing portion P1. In the fixing apparatus 9, different from the fixing apparatus 9H in Comparison Example, the pressure-lowered portion A′ is not formed in the range of the nip N constituted by the pressing portion P1 and the separating portion P2 which are provided by the pressing pad 26. For that reason, stability of the pressure at the nip N can be enhanced.

In the fixing apparatus 9, at the nip N, the pressing pad 100 and the separation roller 56 are integrally provided and the rotatable portion is eliminated and therefore a degree of lowering in the region between the pressing pad 100 and the separation roller 56 can be reduced. For this reason, a degree of the occurrence of uneven glossiness which is image defect generated by stagnation of the air at the lowered portion of the nip pressure can be reduced.

### Embodiment 2

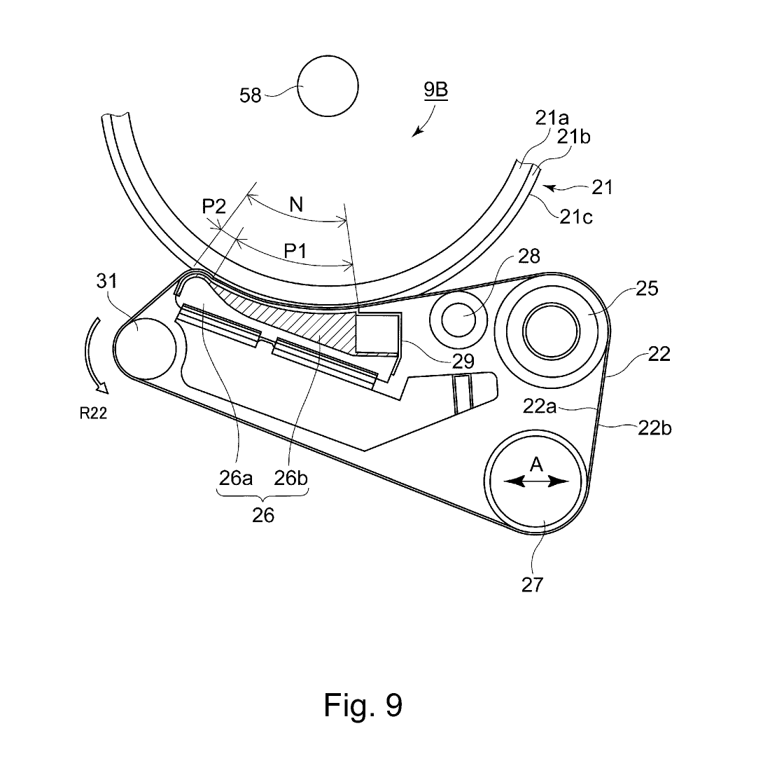

FIG. 9 is an illustration of a structure of a fixing apparatus 9B in Embodiment 2. The fixing apparatus 9B in this embodiment is provided, in place of the fixing apparatus 9 in Embodiment 1, in the image forming apparatus 100 shown in FIG. 1. In FIG. 9, the fixing roller 21, the pressing belt 22, the halogen lamp heater 58, the pressing mechanism and the like are constituted identical to those in Embodiment 1 and are represented by the same reference numerals or symbols as those in FIG. 6, thus being omitted from redundant description.

As shown in FIG. 9, the pressing belt 22 is a seamless endless belt including a polyimide base layer 22a of 90 mm in diameter and 100 μm in thickness. Onto the base layer 22a, a 0.2 mm-thick elastic layer 22b of a silicone rubber material is coated.

The pressing belt 22 is stretched by an entrance roller 25, a pressing pad 26, a steering roller 27 and a driving roller 31. The entrance roller 25 and the steering roller 27 are rotated by rotation of the pressing belt 22.

The driving roller 31 is rotated by receiving a driving force from an unshown driving motor, and rotationally drives the pressing belt 22. The pressing belt 22 is rotated by the driving force inputted into the driving roller 31.

The entrance roller 25 is a stretching roller provided in an entrance portion where the recording material enters the fixing apparatus 9B, and a position of its rotation center shaft is fixed to a frame of the fixing apparatus 9B so that a recording material conveying path is not changed. The steering roller 27 effects lateral movement (deviation) control of the pressing belt 22 while applying a predetermined tension to the pressing belt 22. The steering roller 27 is controlled by the driving mechanism 112 and the control device 110 so that its end portion is moved in an arrow A direction to keep the pressing belt 22 at a certain thrust position relative to the entrance roller 25.

An oil applying roller 28 is constituted by a sponge roller and applies oil onto an inner surface of the pressing belt 22, so that a lubricating performance and heat conducting performance between the pressing belt 22 and the pressing pad 26 are enhanced. To the oil applying roller 28, silicone oil as a lubricant is supplied from an unshown oil supplying device.

The pressing pad 26 forms a double structure by applying the silicone rubber elastic layer 26b onto the stainless pressing pad base 26a.

The pressing pad base 26a is a member of stainless steel, and the elastic layer 26b is silicon rubber having an ASKER hardness Hs of 30 degrees. The hardness of the pressing pad base 26b is larger than that of the elastic layer 26b. At the pressing portion P1, the elastic layer 26b has a shape having curvature of 30 mm in diameter and has a shape such that it contacts a rectilinear line parallel to the pressing pad base 26a at an entrance portion of the nip. The thickness of the elastic layer 26b is 3 mm at the pressing portion P1 and 0.5 mm at the separating portion P2.

The pressing pad 26 forms the nip N. The nip N is constituted by the pressing portion P1, where the pressing belt 22 is uniformly press-contacted to the fixing roller 21, and the separating portion P2 where the pressing belt 22 enters the fixing roller 21 more than at the pressing portion P1. The pressure-lowered portion A′ (FIG. 8) is not present between the pressing portion P1 and the separating portion P2.

The pressing pad 26 is urged toward the fixing roller 21 by an unshown pressing mechanism (spring) provided at each of longitudinal end portions of the pressing pad base 26a. The pressing mechanism applies pressure of 980N (100 kgf) in total to the pressing pad 26. As a result, at the separating portion P2 where the pressing belt 22 enters the fixing roller 21 more than at the pressing portion P1 where the pressing belt 22 is uniformly pressed, the elastic layer 21b of the fixing roller 21 is locally dented, so that ability of curvature-separating the recording material P from the surface of the fixing roller 21 is enhanced. In Embodiment 2, at the separating portion P2, an outer diameter is set at 4 mm, so that a recording material separating performance is enhanced. With a decreasing outer diameter at the separating portion P2, a force for separating the recording material P from the surface of the fixing roller 21 becomes stronger. The thickness of the pressing pad base 26a at the pressing portion P1 is smaller than that at the separating portion P2.

The thickness of the elastic layer and the thickness of the pressing pad base 26a are those with respect to a direction perpendicular to the surface of the pressing pad base (base layer). As described above, by adjusting the thickness of the elastic layer 26b and the thickness of the pressing pad base 26a, a hardness at the separating portion P2 measured from above the sliding sheet 29 can be made larger than that at the pressing portion P1. As a result, a separating property of the recording material P can be enhanced without providing a separating member separately from the pressing pad 26. In this embodiment, the shape of the pressing pad base 26a at the separating portion P2 is an arcuate shape.

The pressing pad 26 is covered with a sheet material containing a fluorine-containing resin material in at least a range from a position, where the pressing belt 22 is changed in direction, to the entrance of the nip N via the exit of the nip N. The sliding surface of the pressing pad 26 with the pressing belt 22 is covered with the sheet. Specifically, the sliding sheet 29 is provided so as to cover a whole region of the elastic layer 26b, so that a sliding resistance between the pressing pad 26 and the pressing belt 22 is alleviated. As the sliding sheet 29, a 100 μm-thick glass cloth sheet coated with a fluorine-containing resin material (PTFE) is used.

The elastic layer 26b provided to the pressing pad 26 is deformed depending on pressure, so that a contact surface of the sliding sheet 29 contacting the inner (back) surface of the pressing belt 22 follows (matches) an outer peripheral surface of the fixing roller 21. The pressing pad 26 is urged toward the fixing roller 21 under a load of a certain value or more, so that the elastic layer 26b is deformed and thus the sliding sheet 29 is deformed to follow the outer peripheral surface of the fixing roller 21. Therefore, when The pressing pad 26 causes the pressing belt 22, to press-contact the fixing roller 21, the pressing belt 22 is press-contacted to the fixing roller 21 with no clearance.

At this time, a pressure distribution of the pressing pad 26 at the nip N is such that the pressure is substantially constant at the pressing portion P1 and that a peak pressure at the separating portion P2 is higher than that at the pressing portion P1.

In the fixing apparatus 9B in Embodiment 2, different from the fixing apparatus 9H in Comparison Example shown in FIG. 8, the pressure-lowered portion A′ is not formed at the nip N constituted by the pressing portion P1 and the separating portion P2 which are provided by the pressing pad 26. Thus, stability of the pressure at the nip N can be enhanced.

Therefore, uneven glossiness and improper fixing resulting from partial generation of the clearance at the boundary between the recording material P and the fixing roller 21 by the air or the water vapor can be reduced.

### Embodiment 3

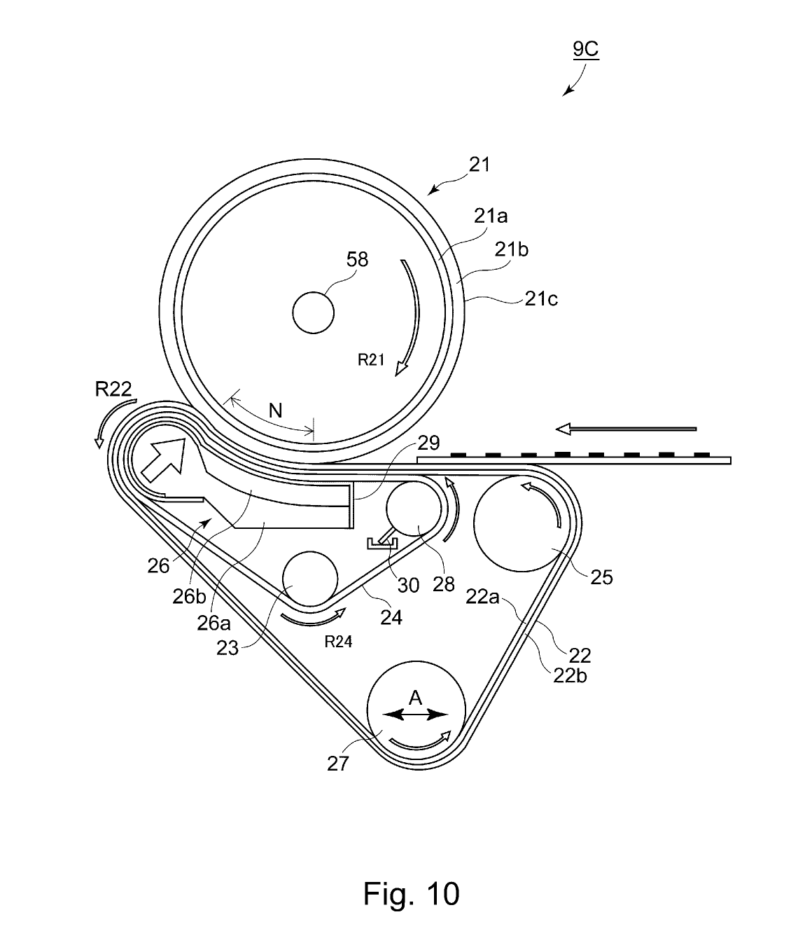

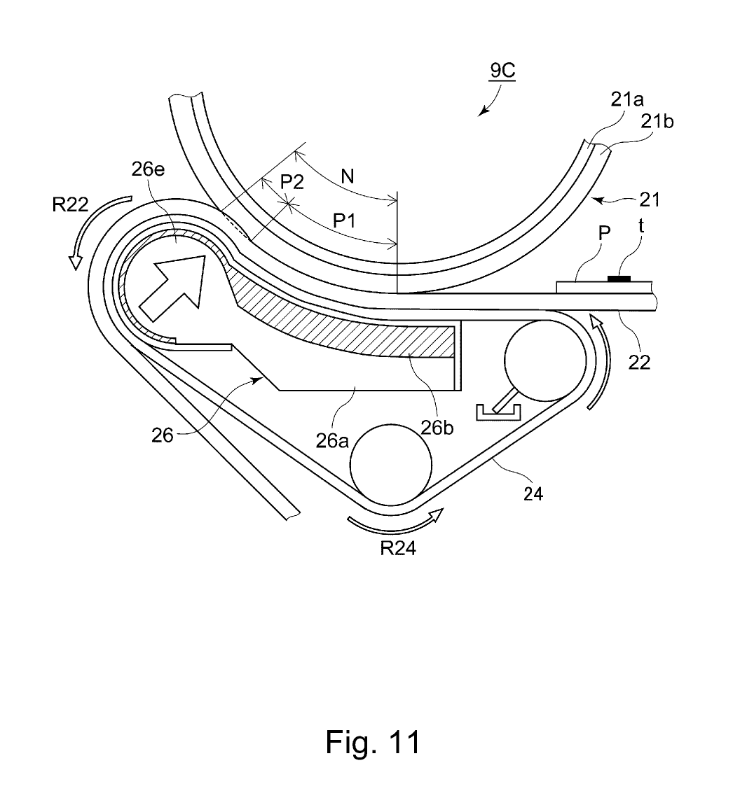

FIG. 10 is an illustration of a structure of a fixing apparatus 9C in Embodiment 3. FIG. 11 is an enlarged view of a nip in the neighborhood of a pressing pad. The fixing apparatus 9C in this embodiment is provided, in place of the fixing apparatus 9 in Embodiment 1, in the image forming apparatus 100 shown in FIG. 1. In FIG. 10, the fixing roller 21, the pressing belt 22, the halogen lamp heater 58, the pressing pad 26, the pressing mechanism and the like are constituted identical to those in Embodiment 1 and are represented by the same reference numerals or symbols as those in FIG. 6, thus being omitted from redundant description.

As shown in FIG. 10, a sliding (slidable) belt 24 which is an example of an inner belt member extends around the pressing pad 26 and is provided rotatably in the same direction as that of the pressing belt 22. The pressing pad 26 urges the pressing belt 22 toward the fixing roller 21 via the sliding belt 24.

The pressing belt 22 is a seamless endless belt including a polyimide base layer 22a of 90 mm in diameter and 100 μm in thickness. The pressing belt 22 is stretched by the entrance roller 25, the pressing pad 26 provided with the sliding belt 24, and the steering roller 27 and is rotationally driven by a driving force inputted from an unshown driving motor to the entrance roller 25, thus being rotated in an arrow R22 direction. The entrance roller 25 also functions as a stretching roller disposed adjacent an entrance portion where the recording material enters the fixing apparatus 9C.

The steering roller 27 is controlled with respect to its tilting angle in real time so that lateral movement of the pressing belt 22 detected by an unshown belt edge sensor is cancelled, while applying predetermined tension to the pressing belt 22.

The pressing pad 26 is urged toward the fixing roller 21 by an unshown pressing mechanism (spring) provided at each of longitudinal end portions of the pressing pad base 26a. The pressing mechanism applies pressure of 980N (100 kgf) in total to the pressing pad 26.

The sliding belt 24 is provided by being interposed between the pressing pad 26 and the pressing belt 22. The sliding belt 24 is press-contacted at its outer surface to the inner surface of the pressing belt 22, thus being integrally rotated with the pressing belt 22 by rotation of the pressing belt 22. The sliding belt 24 is rotated while sliding on the pressing pad 26 at its inner surface.

The sliding belt 24 is stretched by a tension roller 23, an oil applying roller 28 and the pressing pad 26, and the oil applying roller 28 always supplies silicone oil as a lubricant to the inner surface of the sliding belt 24.

The sliding sheet 29 alleviates a sliding resistance between the pressing pad 26 and the sliding belt 24 which slide (via the sliding sheet 29) in a pressed (urged) state. The sliding sheet 29 is provided so as to cover a whole region of the elastic layer 26b to alleviate a sliding resistance between the surface of the elastic layer 26b and the inner surface of the sliding belt 24. As the sliding sheet 29, a glass cloth sheet coated with a fluorine-containing resin material (PTFE) is used. The sliding sheet 29 has a thickness of 100 μm.

The elastic layer 26b of the pressing pad 26 is urged toward the fixing roller 21 under a load of a certain value or more, thus being deformed depending on the pressure distribution to deform the contact surface of the sliding sheet 29 in a shape along (following) the outer peripheral surface of the fixing roller 21. The pressing pad 26 urges the fixing roller 21 via the sliding belt 24 and the pressing belt 22, so that the pressing belt 22 is press-contacted to the fixing roller 21 with no clearance.

The pressing pad 26 forms the nip N. The nip N is constituted by the pressing portion P1, where the pressing belt 22 is uniformly press-contacted to the fixing roller 21, and the separating portion P2 where the pressing belt 22 enters the fixing roller 21 more than at the pressing portion P1. At the pressing portion P1, the elastic layer 26b has curvature of 30 mm in diameter and has a contour shape such that it contacts a rectilinear line parallel to the pressing pad base 26a at an entrance portion of the nip. The thickness of the elastic layer 26b is 3 mm at the pressing portion P1 and 0.5 mm at the separating portion P2.

During the fixing, when the fixing roller 21 and the entrance roller 25 are rotationally driven, the pressing belt 22 is rotated in an arrow R22 direction to rotate the inside sliding belt 24 by its rotation. The sliding belt 24 is lubricated at its inner surface with the silicone oil by the oil applying roller 28. It is desirable that the sliding belt 24 has less friction and a high sliding property at its inner surface. An oil application region is limited to the inside of the sliding belt 24, so that the oil application is sufficiently effected to achieve sliding movement at a maximum efficiency and thus a durability lifetime of the sliding sheet 29 or the like can be improved.

By limiting the oil application region to the inside of the sliding belt 24, even when an oil application amount is increased, driving force transmission loss by the entrance roller 25 and a lowering in efficiency of steering control by slip of the steering roller 27 are prevented from occurring. By placing the inner surface of the pressing belt 22 in a non-lubrication state, when the driving force is transmitted by the entrance roller 25, it becomes possible to supply the driving force stably without generating the slip. Also the lateral movement control of the pressing belt 22 by the steering roller 27 can be stably effected reliably without generating the slip.

By separating the function into that of the sliding belt 24 which slides and moves by obtaining a sufficient lubricant and that of the pressing belt 22 subjected to driving and steering control with no lubricant, abrasion (wearing) of the sliding sheet 29, the sliding belt 24 and the pressing belt 22 can be suppressed to improve durability. Concurrently, steering controllability of the pressing belt 22 can be remarkably improved.

In the fixing apparatus 9c in Embodiment 3, similarly as in Embodiment 1, different from the fixing apparatus 9H in Comparison Example shown in FIG. 8, the pressure-lowered portion A′ is not formed at the nip N constituted by the pressing portion P1 and the separating portion P2 which are provided by the pressing pad 26. For that reason, in the case where the unfixed toner image on the recording material, having low air permeability, such as the coated paper is fixed, it is possible to prevent stagnation of the air and water vapor in the unfixed toner layer at a specified position in the nip N. As a result, it is possible to prevent the uneven glossiness resulting from the generation of the gap, between the recording material P and the fixing roller 21, by the air and water vapor.

A pressure distribution of the pressing pad 26 at the nip N is such that the pressure is substantially constant at the pressing portion P1 and that a peak pressure at the separating portion P2 is higher than that at the pressing portion P1. In the fixing apparatus 9C, different from the fixing apparatus 9H in Comparison Example, the pressure-lowered portion A′ is not formed in a whole region of the nip N ranging from the pressing portion P1 to the separating portion P2 which are provided by the pressing pad 26. For that reason, even in the case where the unfixed toner image on the recording material, having the low air permeability, such as the coated paper is fixed, it is possible to prevent the stagnation of the air and water vapor in the unfixed toner layer.

Generation of the gap at the boundary between the recording material P and the fixing roller 21 by partial stagnation of the air and water vapor in the range of the nip N is less. Inhibition of heat conduction from the fixing roller 21 to the recording material P by the stagnated air and water vapor is also less. It is possible to prevent a phenomenon of the uneven glossiness such that the glossiness is different by a difference in heat conductance between a stagnation portion and a non-stagnation portion of the air and water vapor.

In Embodiments 1 to 3, so long as the pressing belt is continuously pressed by the pressing pad from the entrance to the exit of the nip, the present invention can also be carried out in other embodiments in which a part or all of constitutions of Embodiments 1 to 3 are replaced with alternative constitution thereof. For example, in Embodiments 1 to 3, the fixing apparatus in which the nip for the recording material is formed by causing the pressing belt to contact the fixing roller is described but the present invention is similarly applicable to also an example of an fixing apparatus in which a fixing belt (inside of which the pressing pad is disposed) is used in place of the fixing roller.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 022281/2012 filed Feb. 3, 2012, which is hereby incorporated by reference.

What is claimed is:

1. An image heating apparatus comprising:
a rotatable heating member for heating a toner image on a sheet at a nip;
an endless belt for forming the nip between itself and said rotatable heating member; and
a pressing pad for pressing said endless belt toward said rotatable heating member, wherein said pressing pad includes:
a base portion provided extended at least from an entrance portion of the nip to an exit portion of the nip; and
an elastic layer provided on said base portion, wherein said elastic layer has a thickness which is thinner in a first region adjacent the entrance portion of the nip than in a second region adjacent the exit portion of the nip.

2. An image heating apparatus according to claim 1, further comprising a pressing mechanism for pressing said pressing pad toward said rotatable heating member so that pressure in the first region is larger than that in the second region.

3. An image heating apparatus according to claim 2, wherein the pressure in the second region is maximum at the nip.

4. An image heating apparatus according to claim 3, wherein said rotatable heating member includes an elastic layer, and said pressing pad compresses the elastic layer of said rotatable heating member in the second region.

5. An image heating apparatus according to claim 1, wherein said pressing pad includes a sliding sheet which is provided to cover said elastic layer and which is slidable with said endless belt.

6. An image heating apparatus according to claim 1, wherein said elastic layer includes a rubber.

7. An image heating apparatus comprising:
a rotatable heating member for heating a toner image on a sheet at a nip;
an endless belt for forming the nip between itself and said rotatable heating member;
a pressing pad for pressing said endless belt toward said rotatable heating member, wherein said pressing pad includes: a base portion provided extended at least from an entrance portion of the nip to an exit portion of the nip; and an elastic layer provided on said base portion; and
a pressing mechanism for pressing said pressing pad toward said rotatable heating member so that pressure in a first region adjacent the entrance portion of the nip is larger than that in a second region adjacent the exit portion of the nip.

8. An image heating apparatus according to claim 7, wherein the pressure in the second region is maximum at the nip.

9. An image heating apparatus according to claim 8, wherein said rotatable heating member includes an elastic layer, and said pressing pad compresses the elastic layer of said rotatable heating member in the second region.

10. An image heating apparatus according to claim 9, wherein said elastic layer has a thickness which is thinner in a first region adjacent the entrance portion of the nip than in a second region adjacent the exit portion of the nip.

11. An image heating apparatus according to claim 7, wherein said pressing pad includes a sliding sheet which is provided to cover said elastic layer and which is slidable with said endless belt.

12. An image heating apparatus according to claim 7, wherein said elastic layer includes a rubber
